(19) United States
(12) Patent Application Publication
(10) Pub. No.: US 2026/0109044 A1
(43) Pub. Date: Apr. 23, 2026

(54) ROBOT SYSTEM

(71) Applicant: NACHI-FUJIKOSHI CORP., Tokyo (JP)

(72) Inventor: Toru SHIBA, Toyama (JP)

(21) Appl. No.: 19/352,781

(22) Filed: Oct. 8, 2025

(30) Foreign Application Priority Data
Oct. 21, 2024 (JP) 2024-185116

(51) Int. Cl. B25J 9/16; B25J 13/08

(52) U.S. Cl. CPC B25J 9/1692; B25J 13/086; B25J 13/087

(57) ABSTRACT

A robot system includes a robot, a sensor disposed on the robot and configured to output a sensor value indictive of a capacitance formed with an object, a monitoring sensor configured to monitor if there is any object near the sensor, and a control apparatus programmed to determine, in response to a result of monitoring by the monitoring sensor, whether or not there is an object present near the sensor. The control apparatus is further programmed to calibrate the sensor value upon a determination that there is no object present near the sensor.

### RELATED APPLICATIONS

The present application claims priority under 35 U.S.C. §119 to Japanese Patent Application No. 2024-185116 filed on October 21, 2024, the entire content of which is incorporated herein by reference.

### BACKGROUND OF THE INVENTION

### Field of the Invention

The present invention relates to a robot system including a robot and a control apparatus.

### Description of the Related Art

This section of the specification merely describes background information related to the present invention, which may not necessarily relate to the prior art.

There are occasions where a human and a robot collaborate with each other to perform work on a workpiece. The robot used in such work environment is called a collaborative robot. Some collaborative robots are equipped with a capacitive sensor for detecting a nearby object, for example.

Japanese Patent Application Laid-Open No. H09-033317 describes a capacitive sensor for measuring the volume of a target object stored in a container and further describes positioning the sensor electrode and the ground electrode apart from each other at a specific distance to conduct the zero point adjustment.

### SUMMARY OF THE INVENTION

The capacitive sensor forms a capacitance with a nearby object and environmental factors such as temperature and humidity affect its sensor value to have an offset component. For example, Japanese Patent Application Laid-Open No. H09-033317 describes the zero point adjustment but contemplates its application to be for measuring the volumes of stored objects. Besides, the patent requires the sensor and ground electrodes to be disposed as a set away from each other at a specific distance. It thus presents an engineering challenge to implement the method described in Japanese Patent Application Laid-Open No. H09-033317 in a robot including the capacitive sensor. Moreover, since the offset component may change (fluctuate) as the environmental factors change, the sensor value needs to be calibrated to remove the offset component from the sensor value.

In view of the foregoing problems, one or more embodiments of the present invention provide a robot system that can calibrate its sensor value to remove the offset component caused by environmental factors.

To solve the foregoing problems, a robot system according to the present invention includes a robot and a sensor disposed on the robot. The sensor is configured to output a sensor value indicative of a capacitance formed with an object. The robot system further includes a monitoring sensor configured to monitor if there is any object near the sensor. The robot system includes a control apparatus programmed to determine whether or not any object is present near the sensor, based on a result of monitoring by the monitoring sensor. The control apparatus is further programmed to calibrate the sensor value upon a determination that there is no object present near the sensor.

In the robot system according to the present invention, the control apparatus is programmed to, upon a determination that there is no object present near the sensor, perform the zero point adjustment on the sensor value.

In the robot system according to the present invention, the sensor includes a bridge circuit. The bridge circuit includes a detection electrode operable to generate an electric field in a predetermined direction. The control apparatus is configured to calibrate the sensor value to restore the equilibrium of the bridge circuit.

In the robot system according to the present invention, the bridge circuit includes a first resistor and a second resistor, and the control apparatus is further programmed to adjust the resistance of at least one of the first or second resistor to perform the zero point adjustment on the sensor value.

In the robot system according to the present invention, the control apparatus is further programmed to switch between a detection mode where the control apparatus determines, using the sensor value, whether there is an object near the sensor and a calibration mode where the control apparatus calibrates the sensor value, in response to a determination on whether or not there is an object present near the sensor.

According to the robot system of the present invention, the sensor value is calibrated to remove the offset component caused by the environmental factors.

### BRIEF DESCRIPTION OF THE DRAWINGS

FIG. 1 is a schematic diagram showing an overall configuration of an exemplary robot system according to an embodiment of the present invention;

FIG. 2 is a diagram showing a specific configuration of an exemplary sensor of FIG. 1;

FIG. 3 is a diagram showing various exemplary functions implemented by a control apparatus of FIG. 1; and

FIG. 4 is a flowchart showing exemplary processes performed by the control apparatus of FIG. 1.

### DETAILED DESCRIPTION OF THE PREFERRED EMBODIMENTS

Embodiments of the subject matter now will be described in further detail hereinafter with reference to the attached figures. In the figures, identical or corresponding constituents are identified using the same reference numerals, and redundant description is omitted. Also, the some of the figures are not necessarily to scale, as the size of some of the structures or portions of the figures may be exaggerated relative to other structures or portions for illustrative purposes. Further, some of the figures are schematically illustrated to facilitate understanding of the structures represented therein.

### Embodiment

### <Overall Configuration>

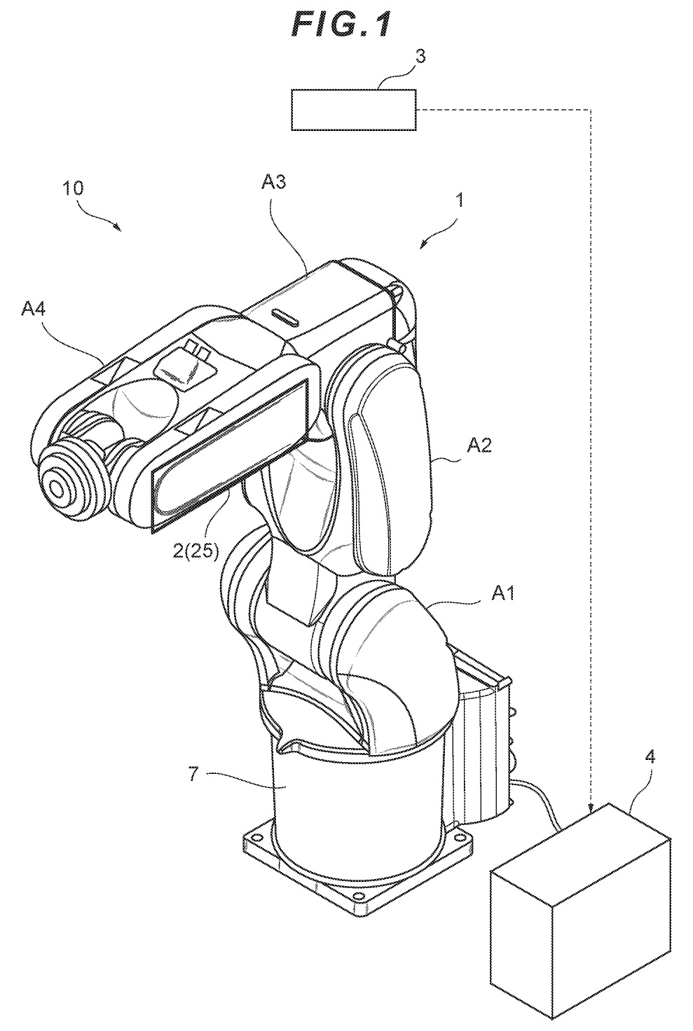

FIG. 1 is a diagram schematically showing an overall configuration of an exemplary robot system 10 according to an embodiment of the present invention.

The robot system 10 is an industrial robot that performs works, such as machining and transportation, on a workpiece. The robot system 10 is a collaborative robot that performs work while sharing the work space with a human worker, for example.

As shown in FIG. 1, the robot system 10 mainly includes a robot 1, a sensor 2, a monitoring sensor 3, and a control apparatus 4.

The robot 1 is an articulated robot and includes a plurality of arms and a plurality of joints. Specifically, the robot 1 includes a base 7, a first arm A1, a second arm A2, a third arm A3, and a fourth arm A4. The number of arms included is not limited to a particular number. The base 7 is the foundation of the robot 1. The base 7 is fixed to the floor surface or a wall surface, for example, and supports the robot arms for movement. The first arm A1 is connected to the base 7 via a rotating shaft. The first arm A1 is rotated by a not-shown motor about the rotating shaft relative to the base 7. Like the first arm A1, the second, third, and fourth arms A2, A3, and A4 are rotated by not-shown motors about rotating shafts, respectively. A tool or the like is attached to the distal end of the fourth arm A4. With the configuration, the arms are connected among themselves from one to the next and can operate by means of the rotating shafts that serve as joints for the arms. The robot 1 executes preprogrammed operations by moving the joints.

The sensor 2 is a capacitive sensor that detects an object such as a human body, without necessitating a physical contact with the object. The sensor 2 outputs a sensor value indicative of a capacitance formed with an object. In the present embodiment, an "object" should be broadly construed and includes human bodies, workpieces, and other objects. For example, the sensor 2 detects a proximity of an object. The sensor 2 may detect a displacement of an object. The present embodiment will be described with an exemplary application to the robot 2 in which the sensor 2 detects a proximity of an object. The sensor value takes a form of an output voltage that is output from the sensor 2, for example.

The sensor 2 is installed on the robot 1. Specifically, the sensor 2 is disposed on one of the arms of the robot 1. The present embodiment will be described with an exemplary configuration in which the sensor 2 is disposed on the fourth arm A4. The installation positions and the number of the sensors 2 installed on the robot 1 shown in FIG. 1 are just exemplary implementations of the invention. The installation positions and the number of sensors 2 installed are not limited to the specific configuration shown in FIG. 1.

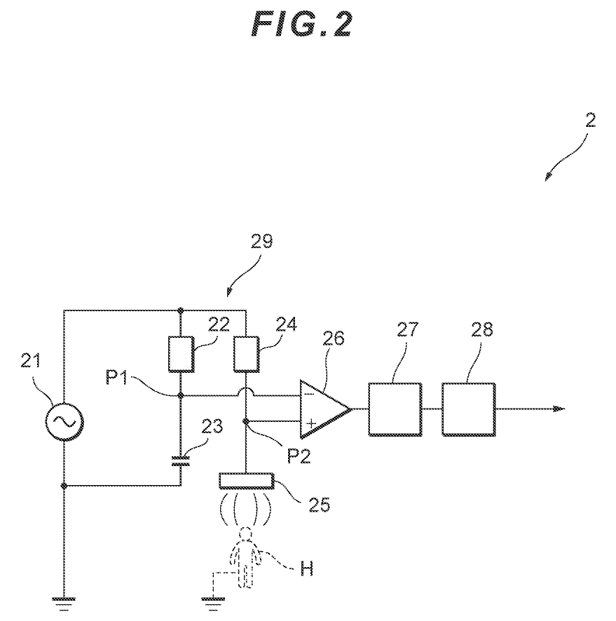

FIG. 2 is a diagram showing an exemplary configuration of the sensor 2. The sensor 2 includes an arbitrary waveform generator 21, a first resistor 22, a capacitor 23, a second resistor 24, a detection electrode 25, an instrumentation amplifier 26, a lock-in amplifier 27, and an analog-to-digital (A/D) converter 28. The first resistor 22, the capacitor 23, the second resistor 24, and the detection electrode 25 constitute a bridge circuit 29. The bridge circuit 29 is an RC bridge circuit, for example.

The arbitrary waveform generator 21 comprises an oscillation circuit that generates a sine wave voltage, a rectangular wave voltage, or the like at a predetermined frequency with respect to a ground potential (GND potential), or a reference potential. The signal generated by the arbitrary waveform generator 21 is input to the bridge circuit 29. Specifically, the first resistor 22 is electrically connected at its one end to the arbitrary waveform generator 21 and at the other end to the capacitor 23. The capacitor 23 is electrically connected at its one end to the first resistor 22 and at the other end to the reference potential of the arbitrary waveform generator 21. Between the first resistor 22 and the capacitor 23 there is illustrated a point P1. The second resistor 24 is electrically connected at its one end to the arbitrary waveform generator 21 and at the other end to the detection electrode 25. Between the second resistor 24 and the detection electrode 25, there is illustrated a point P2. The first resistor 22 and the second resistor 24 are formed with variable resistors whose resistances are variable. For example, the first and second resistors 22 and 24 are formed with digital potentiometers. The resistances of the first and second resistors 22 and 24 are adjusted by the control apparatus 4, as described below. The capacitor 23 is set equal to a predetermined capacitance. The first resistor 22 and the second resistor 24 each may be formed with a single resistor (variable resistor) or a collection of resistors. The capacitor 23 may be formed with a single capacitor or a collection of capacitors. The bridge circuit 29 is adjusted to restore the equilibrium when the sensor 2 is not detecting any object (when there is no object present near the detection electrode 25). The equilibrium refers to the state in which the point P1 and the point P2 exhibit an identical voltage.

The detection electrode 25 is electrically connected to the second resistor 24. For example, the detection electrode 25 is formed in a shape of a flat plate having a rectangular plane form. However, the shape of the detection electrode 25 is not limited thereto. The detection electrode 25 may be formed in any shapes as long as the shape matches the outer configuration of the arm. The sensor 2 generates an electric field in a predetermined direction from the detection electrode 25. Specifically, the sensor 2 generates an electric field in a direction away from the main body of the robot 1, to which the sensor 2 is attached. In other words, the sensor 2 generates an electric field around the robot 1. The detection electrode 25 forms a capacitance with a nearby object. The capacitance varies with changes of the distance between the detection electrode 25 and the nearby object. FIG. 2 shows a human H as an example of the object. Suppose that the human H has a potential equivalent to the reference potential. The detection electrode 25 forms a capacitance with the human H and constitutes a part of the bridge circuit 29. A shield electrode, an active shield electrode, or the like may be disposed on the side of the detection electrode 25, (or the main body side of the robot 1), opposite to the side in the direction in which the electric field is generated.

The instrumentation amplifier 26 is electrically connected at its negative input terminal to the point P1 between the first resistor 22 and the capacitor 23 and at its positive input terminal to the point P2 between the second resistor 24 and the detection electrode 25. The instrumentation amplifier 26 then amplifies the difference between the input voltages applied to the positive and negative input terminals. The output terminal of the instrumentation amplifier 26 is electrically connected to the lock-in amplifier 27. The amplified signal from the instrumentation amplifier 26 is synchronously detected by the lock-in amplifier 27 and then converted from an analog signal into a digital signal by the A/D converter 28. The lock-in amplifier 27 uses the signal from the arbitrary waveform generator 21 as a reference signal for the synchronous detection. The sensor value output from the sensor 2 thus represents a value corresponding to the capacitance formed in accordance with the distance between the detection electrode 25 and the object. Since the bridge circuit 29 is designed to strike the equilibrium when the sensor 2 is not detecting any object, the sensor value that is output when no object is being detected is ideally zero (the reference value in the equilibrium).

The specific circuit configuration of the sensor 2 is not limited to that shown in FIG. 2, as long as the sensor value is output in correlation with the capacitance formed between the detection electrode 25 and a nearby object. The sensor value is not limited to the output of the A/D converter 28. The output of the lock-in amplifier 27 or other values (such as the output of the instrumentation amplifier 26) may be taken as the sensor value.

The monitoring sensor 3 monitors the presence of any objects around the sensor 2. In the present embodiment, the monitoring sensor 3 comprises a camera (an imaging apparatus) such as a three-dimensional (3D) camera. An infrared camera, an optical sensor or the like may be used as the monitoring sensor 3 as long as the presence or absence of any objects can be monitored.

The monitoring sensor 3 captures images within a predetermined range around the sensor 2 (in the vicinity of the sensor 2). The predetermined range is set to include the range of the electric field generated by the sensor 2, for example. In other words, the monitoring sensor 3 performs monitoring within the range in which the sensor 2 can detect objects.

For example, the monitoring sensor 3 may be located above the robot 1 as shown in FIG. 1. The monitoring sensor 3 can thereby monitor, from above, the presence or absence of an object around the sensor 2 mounted on the robot 1.

Monitoring results from the monitoring sensor 3 are output to the control apparatus 4.

The control apparatus 4 is an information processing apparatus that controls the operation of the robot 1. Moreover, in the present embodiment, the control apparatus 4 calibrates the sensor 2. For example, the control apparatus 4 includes a central processing unit (CPU), a memory, a communication device, and a storage device. The CPU is an example of a processor, and the processor performs various functions by executing preset programs stored in storage circuits such as the storage device and memory. The communication device includes a communication interface or the like. The storage device includes a hard disk or the like and stores information including various programs executed to perform processes. The control apparatus 4 can be implemented using an information processing apparatus such as a dedicated or general-purpose computer.

### <Functional Configuration>

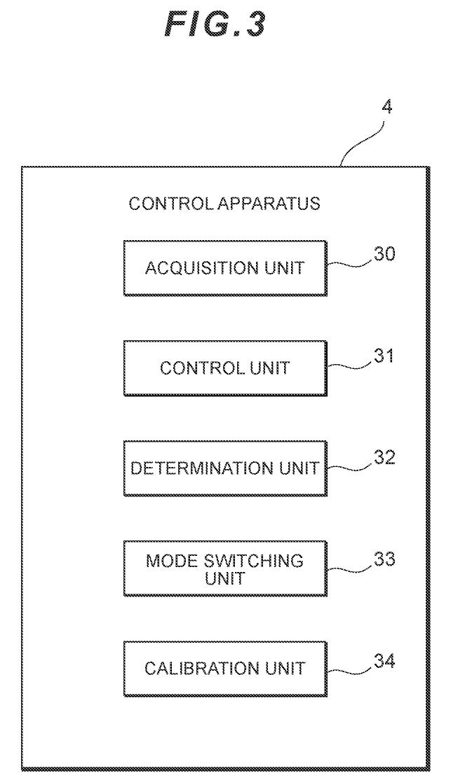

FIG. 3 shows various exemplary functions of the control apparatus 4. The control apparatus 4 includes an acquisition unit 30, a control unit 31, a determination unit 32, a mode switching unit 33, and a calibration unit 34. The functions of the control apparatus 4 are implemented by the CPU or the like executing programs stored in the storage device or the like.

The acquisition unit 30 acquires the sensor value from the sensor 2. The acquisition unit 30 also acquires the monitoring results from the monitoring sensor 3. For example, the acquisition unit 30 acquires images, captured by the monitoring sensor 3, of environs surrounding the sensor 2.

The control unit 31 controls the operation of the robot 1. Specifically, the control unit 31 controls the operation of each arm of the robot 1 so that the robot 1 performs preprogramed operations. Examples of the preprogrammed operations include operations performed on a workpiece. More specifically, the control unit 31 controls rotation of the rotating shafts that constitute the joints of the robot 1.

Using the sensor value acquired from the sensor 2, the control unit 31 also stops the operation of the robot 1. Specifically, the control unit 31 compares the sensor value with a threshold and determines whether any object is present near the robot 1. When the control unit 31 determines that an object is present near the robot 1, the control unit 31 stops the operation of the robot 1. For example, when the sensor value increases as the object approaches, the control unit 31 stops the operation of the robot 1 when the sensor value reaches or exceeds the threshold. The control unit 31 stops the operation even when the robot 1 is in the middle of performing a preprogrammed operation. Note that to avoid collision with an approaching object, the control unit 31 may not need to stop the operation of the robot 1 and may alternatively decelerate the operation of the robot 1 or operate the robot 1.

The determination unit 32 determines whether or not there is any object present around the sensor 2 based on the monitoring results from the monitoring sensor 3. Specifically, the determination unit 32 analyzes the captured images showing the environs surrounding the sensor 2 and determines whether or not there is any object present near the sensor 2. For example, if the images show an object present near the sensor 2, the determination unit 32 determines that there is an object present near the sensor 2. The determination by the determination unit 32 that there is an object present near the sensor 2 may be relied upon as an indication that it is highly likely that an object is present near the sensor 2. When the images show no object near the sensor 2, the determination unit 32 determines that no object is present near the sensor 2. The determination by the determination unit 32 that no object is present near sensor 2 may be relied upon as an indication that it is highly likely that no object is present near the sensor 2. With the function, the determination unit 32 determines whether or not any object is present within the electric field generated by the sensor 2 (within the detection range of an object). In other words, it is determined whether the sensor 2 is detecting any object nearby. When an object is present near the sensor 2, the sensor value is output that is indicative of the capacitance formed between the detection electrode 25 and the object. When no object is present near the sensor 2, the sensor value is output that is indicative of no capacitance formed between the detection electrode 25 and any object.

The mode switching unit 33 switches between a detection mode and a calibration mode in response to a determination on whether or not any object is present near the sensor 2. Specifically, if the determination unit 32 determines that an object is present near the sensor 2, the mode switching unit 33 selects the detection mode. If the determination unit 32 determines that no object is present near the sensor 2, the mode switching unit 33 selects the calibration mode. In response to change of the determination regarding the presence or absence of an object near the sensor 2, the mode switching unit 33 switches between the detection mode and the calibration mode.

The detection mode is implemented to probe the presence or absence of an object by monitoring the sensor value acquired from the sensor 2. Specifically, in the detection mode, the control unit 31 determines whether or not any object is present near the robot 1 using the sensor value and if necessary, stops the operation of the robot 1. In the detection mode, the calibration of the sensor value is not performed as described below.

The calibration mode is implemented to calibrate the sensor value output from the sensor 2. Specifically, in the calibration mode, the calibration unit 34, as described below, calibrates the sensor value from the sensor 2. In the calibration mode, the control unit 31 does not stop the operation of the robot 1 based on the sensor value.

The calibration unit 34 calibrates the sensor value. The sensor value may have an offset component that arises from environmental factors such as temperature and humidity. Specifically, the offset component is brought in the sensor value because the capacitance sensed at the detection electrode 25 is affected by the surrounding environment. The offset component of the sensor value also changes with changes in the environmental factors. The calibration unit 34 thus calibrates the sensor value to suppress the offset component that is brought in the sensor value because of changes of the environmental factors.

Specifically, when it is determined that no object is present near the sensor 2, the calibration unit 34 performs the calibration on the sensor value. The calibration performed by the calibration unit 34 includes, for example, a zero point adjustment. More specifically, the calibration unit 34 calibrates the sensor value to bring it back close to the zero point. When no object is present near the sensor 2, the bridge circuit 29 is supposed to strike the equilibrium and the sensor value is supposed to be equal to zero (reference value). However, even when no object is present near the sensor 2, an offset component can appear in the sensor value because of the environmental factors. In other words, the sensor value that is output when it is determined that no object is present near the sensor 2 is considered representing the offset component. The calibration unit 34 therefore performs the zero point adjustment on the sensor value based on the sensor value that is output when it is determined that no object is present near the sensor 2. The calibration unit 34 performs the calibration, in response to a determination that no object is present near the sensor 2, so that the sensor value becomes zero.

Specifically, the calibration unit 34 takes the sensor value that is output when it is determined that no object is present near the sensor 2 and adjusts the bridge circuit 29 to restore the equilibrium so that the sensor value becomes zero. To adjust the bridge circuit 29, the calibration unit 34 adjusts the resistance of at least one of the first and second resistors 22 and 24. In other words, the calibration unit 34 takes the sensor value and adjusts the first resistor 22 and/or the second resistor 24, so that the bridge circuit 29, which includes the detection electrode 25 that is affected by environmental factors, restores the equilibrium. The adjustment of the first resistor 22 and/or the second resistor 24 is considered completed when the sensor value becomes zero when it is determined that no object is present near the sensor 2.

The calibration is considered completed not only when the sensor value is brought equal to zero, but also when the sensor value is brought close to zero. While the foregoing embodiment describes that the calibration is performed by taking the sensor value, the calibration may not require taking the sensor value. Instead, the offset component may be estimated from the environmental factors such as temperature and humidity, and the first resistor 22 and/or the second resistor 24 may be adjusted to suppress the offset component. While the foregoing embodiment describes that the calibration is performed by adjusting the first resistor 22 and/or the second resistor 24, the calibration may be performed using other adjustment methods selected in accordance with the configuration of the sensor 2.

With the configuration described above, the calibration unit 34 calibrates the sensor value to counter the environmental factors. Since the calibration unit 34 can perform the calibration when it is determined that no object is present near the sensor 2, the calibration can be performed at occasions even while the robot 1 is operating. Performing the calibration at occasions can also suppress changes of the offset component caused by changes of the environment factors.

### <Processing Procedure>

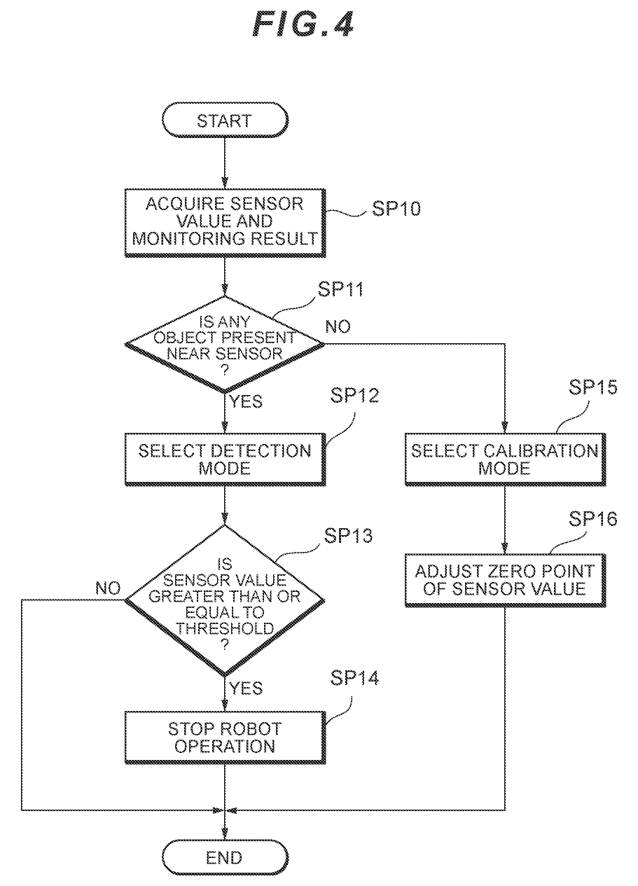

FIG. 4 is a flowchart showing an example of a processing procedure performed by the control apparatus 4 according to the present embodiment. The processes performed in the following steps are repeated at a predetermined control cycle while the robot 1 is in operation. Note that the order and content of the following steps can be changed where appropriate.

### (Step SP10)

The acquisition unit 30 acquires the sensor value from the sensor 2 and also acquires the monitoring results from the monitoring sensor 3. The process then proceeds to step SP11.

### (Step SP11)

The determination unit 32 determines the presence or absence of an object near the sensor 2, based on the monitoring results from the monitoring sensor 3. If it is determined that an object is present near the sensor 2, the process proceeds to step SP12. If it is determined that no object is present near the sensor 2, the process branches to step SP15.

### (Step SP12)

The mode switching unit 33 selects the detection mode as the operation mode to be implemented. The process then proceeds to step SP13.

### (Step SP13)

The control unit 31 determines whether the sensor value is greater than or equal to a threshold. If the sensor value is greater than or equal to the threshold, the process proceeds to step SP14. If the sensor value is less than the threshold, the process ends.

### (Step SP14)

The control unit 31 stops the operation of the robot 1. The process then ends. Note that if the operation of the robot 1 is stopped by the control unit 31, the operation of the robot 1 may be resumed, for example, by an instruction from an operator to resume the operation.

### (Step SP15)

The mode switching unit 33 selects the calibration mode as an operation mode to be implemented. The process then proceeds to step SP16.

### (Step SP16)

The calibration unit 34 performs the zero point adjustment on the sensor value by adjusting the bridge circuit 29 to restore the equilibrium. The process then ends.

with the processes performed as described above, an object is detected, and the calibration of the sensor value is performed while the robot 1 is in operation. In particular, the presence or absence of an object near the sensor 2 is determined based on the monitoring results from the monitoring sensor 3. If it is determined highly likely that no object is present, the sensor value is calibrated. If it is determined highly likely that an object is present, an object is detected with high accuracy using the sensor value of the sensor 2.

### <Operation and Effects>

As described above, in the present embodiment, the presence or absence of an object near the sensor 2 is monitored, and the sensor value is calibrated when no object is present nearby. The sensor value can be calibrated at windows of time when no object is present near the sensor 2. In other words, the sensor value can be calibrated even when an offset component appears in the sensor value because of the environmental factors such as temperature and humidity, and the offset component changes as the environmental factors change. Moreover, by utilizing the windows of time when no object is present near the sensor 2, the calibration can be performed accordingly to the operation of the robot 1.

When no object is present near the sensor 2, the sensor 2 can be calibrated by means of the zero point adjustment since the sensor 2 is not detecting any object.

Moreover, the calibration can be performed by adjusting the bridge circuit 29 including the detection electrode 25 to restore the equilibrium.

In calibrating the bridge circuit 29 including the first resistor 22 and the second resistor 24, the bridge circuit 29 can be efficiently adjusted to restore the equilibrium by adjusting the resistance of at least one of the first and second resistors 22 and 24. In other words, the zero point adjustment of the sensor 2 is efficiently performed.

The detection mode and the calibration mode are switched between them based on results of determination on whether or not an object is present near the sensor 2. The detection mode and the calibration mode can thus be executed appropriately during the operation of the robot 1, whereby both the object detection and the calibration of the sensor 2 can be performed.

### Modification

The present invention is not limited to the foregoing embodiments. In other words, modifications made by those skilled in the art through appropriate design changes to the foregoing embodiments are also included in the scope of the present invention as long as such modifications have the features of the present invention. Moreover, the components included in the foregoing embodiments and modifications described below can be combined as far as technically feasible. Such combinations are also included in the scope of the present invention as long as the combinations have the features of the present invention.

For example, it is described in the foregoing embodiments that the sensor 2 is disposed on the arm (the fourth arm A4) of the robot 1 as an example. The components of the sensor 2 shown in FIG. 2 may be disposed on the arm or alternatively some of the components may be disposed on the arm. At least the detection electrode 25 constituting the sensor 2 needs to be disposed on the robot 1 (on the arm in particular).

It is described in the foregoing embodiments that the monitoring sensor 3 is positioned above the robot 1 as an example. However, the installation position of the monitoring sensor 3 is not limited to the foregoing. The monitoring sensor 3 may be installed on the floor or on other devices present near the robot 1, or disposed on the robot 1 i.e., on an arm thereof. In other words, as long as the monitoring sensor 3 can monitor objects near the sensor 2, the installation position is not limited to any particular positions. Moreover, the monitoring sensor 3 may be implemented using a plurality of cameras. For example, an object present near the sensor 2 can be more accurately monitored by using the monitoring sensor 3 formed with a plurality of cameras installed at different locations. The monitoring sensor 3 may be fixed to have an imaging range fixed in advance, or movable to have an imaging range variable depending on the orientation of the robot 1 or the position of the sensor 2.

It is described in the foregoing embodiments that the robot 1 is equipped with one sensor 2 as an example. However, the robot 1 may be equipped with a plurality of sensors 2. when equipped with a plurality of sensors 2, the control apparatus 4 calibrates the individual sensors 2. The single monitoring sensor 3 may monitor objects near the plurality of sensors 2.

It is described in the foregoing embodiments that the determination unit 32 determines that an object is present near the sensor 2 if the images that capture the environs surrounding the sensor 2 show the presence of an object near the sensor 2. However, the present invention is not limited thereto. For example, the determination unit 32 may also determine that an object is present near the sensor 2 if the images that capture the environs surrounding the sensor 2 does not show that no object is present near the sensor 2. In other words, the determination unit 32 may determine that an object is present near the sensor 2 if it is indeterminable, because of obstacles and other factors, that no object is present near the sensor 2.

It is described in the foregoing embodiments that the control unit 31 does not stop the operation of the robot 1 in reliance on the sensor value if acquired in the calibration mode. However, the control unit 31 may stop the operation of the robot 1 in reliance on the sensor value acquired even in the calibration mode.

It is described in the foregoing embodiments that the calibration unit 34 calibrates the sensor value by adjusting the bridge circuit 29 to restore the equilibrium when it is determined that no object is present near the sensor 2. However, the calibration may be made using other methods. For example, the sensor value may be calibrated equal to a calibration correction value that is the sensor value output when it is determined that no object is present near the sensor 2. The calibration unit 34 sets the sensor value equal to a calibration correction value that is the sensor value output when it is determined that no object is present near the sensor 2. In other words, the calibration correction value represents the offset component of the sensor value caused by the environmental factors. The calibration correction value set accordingly is used, for example, by the control unit 31. For example, the control unit 31 excludes the calibration correction value from the sensor value acquired from the sensor 2, and compares the resulting sensor value with a threshold to determine whether any object is present near the robot 1. An example of excluding the calibration correction value from the sensor value is subtracting the calibration correction value from the sensor value. The control unit 31 stops the operation of the robot 1 using the resulting sensor value in which an offset component is suppressed. With this method being implemented, the calibration unit 34 may calibrate the sensor value equal to the calibration correction value that is the sensor value output when it is determined that no object is present near the sensor 2.

What is claimed is:

1. A robot system comprising:
a robot;
a sensor disposed on the robot and configured to output a sensor value indicative of a capacitance created with an object;
a monitoring sensor configured to monitor if there is any object near the sensor; and
a control apparatus programmed to determine, in response to a result of monitoring by the monitoring sensor, whether or not an object is present near the sensor, wherein the control apparatus is further programmed to calibrate the sensor value, upon a determination that there is no object present near the sensor.

2. The robot system according to claim 1, wherein the control apparatus is further programmed to, upon a determination that there is no object present near the sensor, perform a zero point adjustment on the sensor value.

3. The robot system according to claim 1, wherein:
the sensor includes a bridge circuit including a detection electrode operable to generate an electric field in a predetermined direction; and
the control apparatus is further programmed to calibrate the sensor value to restore an equilibrium of the bridge circuit.

4. The robot system according to claim 3, wherein:
the bridge circuit includes a first resistor and a second resistor; and
the control apparatus is further programmed to adjust a resistance of at least one of the first and second resistors to perform a zero point adjustment on the sensor value.

5. The robot system according to claim 1, wherein the control apparatus is further programmed to switch between a detection mode where the control apparatus determines, using the sensor value, whether there is any object present near the sensor and a calibration mode where the control apparatus calibrates the sensor value, in response to a result of determination by the control apparatus on whether or not there is any object present near the sensor.

6. The robot system according to claim 2, wherein:
the sensor includes a bridge circuit including a detection electrode operable to generate an electric field in a predetermined direction; and
the control apparatus is further programmed to calibrate the sensor value to restore an equilibrium of the bridge circuit.

7. The robot system according to claim 2, wherein the control apparatus is further programmed to switch between a detection mode where the control apparatus determines, using the sensor value, whether there is any object present near the sensor and a calibration mode where the control apparatus calibrates the sensor value, in response to a result of determination by the control apparatus on whether or not there is any object present near the sensor.
